(19) United States
(12) Patent Application Publication
(10) Pub. No.: US 2014/0297028 A1
(43) Pub. Date: Oct. 2, 2014

(54) DEVICE FOR DISPENSING MEDICATION USED FOR OFFICE-BASED OPIATE DEPENDENCE TREATMENT

(71) Applicant: Edward J. Bilotti, Belle Mead, NJ (US)

(72) Inventor: Edward J. Bilotti, Belle Mead, NJ (US)

(21) Appl. No.: 13/854,012

(22) Filed: Mar. 29, 2013

(51) Int. Cl. A61J 7/04; G06F 19/00

(52) U.S. Cl. CPC A61J 7/0481; G06F 19/3462; A61J 2007/0427
USPC 700/237

(57) ABSTRACT

A battery-powered, rechargeable, handheld device dispenses medication film strips in a controlled way. The device is password protected, restricts doses, communicates wireless with a server host so that a doctor and pharmacist can monitor the device and can destroy the medication remotely if the device is lost, stolen or tampered with. The device may be trackable by GPS location. Software can track the device as well as a doctor's caseload to assure compliance with regulations. The device is an automated device that uses sophisticated electronics to remove the human element and force the patient to adhere to a programmed regimen. The device also simplifies the process of monitoring and tracking for the doctor. The problem of accidental child exposure is eliminated. The problem of abuse and diversion of the drug is effectively controlled and limited. Nothing is left to human interpretation or variability in practice.

### BACKGROUND OF THE INVENTION

The present invention relates to medication dispensing devices and, more particularly, to a device for dispensing medication used for office-based opiate dependence treatment in a controlled manner that communicates wirelessly with a server host where local computer software application installed on a physician's computer are all integrated with the device to manage treatment.

Buprenorphine/naloxone is a medication used for office-based treatment of opioid dependence. It is available as a sublingual film strip packaged in a flat foil package. The patient removes the strip from the foil wrapper and places the strip under the tongue where it dissolves in minutes.

There is a growing problem of misuse, abuse, and diversion among patients being prescribed this medication. Doctors must be specially trained and certified to prescribe it and may only have a limited caseload of patients under Federal regulations. There is also a public health problem involving accidental child exposure to the medication. The nature of the disease of addiction is such that patients are prone to overuse, misuse, or abuse of the drug, and optimal treatment requires a strict controlled regimen of medication, counseling, and participation in 12-step meetings.

Conventional approaches for dealing with the above problems involve education and raising awareness. These methods rely solely on human being doing the “right” thing, which is counter to the nature of the disease being treated.

Moreover, educating doctors and raising awareness of problems in the community or public health problems in no way guarantees control.

As can be seen, there is a need for an improved method and device for dispensing medication used for office-based opiate dependence treatment in a controlled manner.

### SUMMARY OF THE INVENTION

In one aspect of the present invention, a device for dispensing medication comprises a programming connection adapted to permit programming of the device, the programming connection being either a wireless connection or a physical connection; a dispenser adapted to dispense the medication at a predetermined medicine issuance time; and a plurality of buttons adapted to permit a user to enter a code at the medicine issuance time, prior to the dispenser dispensing the medication.

In another aspect of the present invention, a device for dispensing dosage strips of medication comprises a programming connection adapted to permit programming of the device, the programming connection being either a wireless connection or a physical connection; a dispenser adapted to dispense the medication at a predetermined medicine issuance time; a plurality of buttons adapted to permit a user to enter a code at the medicine issuance time, prior to the dispenser dispensing the medication; and a global positioning device disposed in the device for locating the device if lost.

These and other features, aspects and advantages of the present invention will become better understood with reference to the following drawings, description and claims.

### BRIEF DESCRIPTION OF THE DRAWINGS

FIG. 1 is a perspective view of a medication dispensing device, in use, according to an exemplary embodiment of the present invention;

FIG. 2 is a perspective/schematic view of the medication dispensing device of FIG. 1;

FIG. 3 is an exploded perspective view of the medication dispensing device of FIG. 1; and FIG. 4 is a bottom perspective view of the medication dispensing device of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a battery-powered, rechargeable, handheld device that dispenses medication film strips in a controlled way. The device is password protected, restricts doses, communicates wireless with a server host so that a doctor and pharmacist can monitor the device and can destroy the medication remotely if the device is lost, stolen or tampered with. The device may be trackable by GPS location. Software of the present invention may track the device as well as a doctor's caseload to assure compliance with regulations. The device of the present invention is an automated device that uses sophisticated electronics to remove the human element and force the patient to adhere to a programmed regimen. It also simplifies the process of monitoring and tracking for the doctor. The problem of accidental child exposure is eliminated. The problem of abuse and diversion of the drug is effectively controlled and limited. Nothing is left to human interpretation or variability in practice.

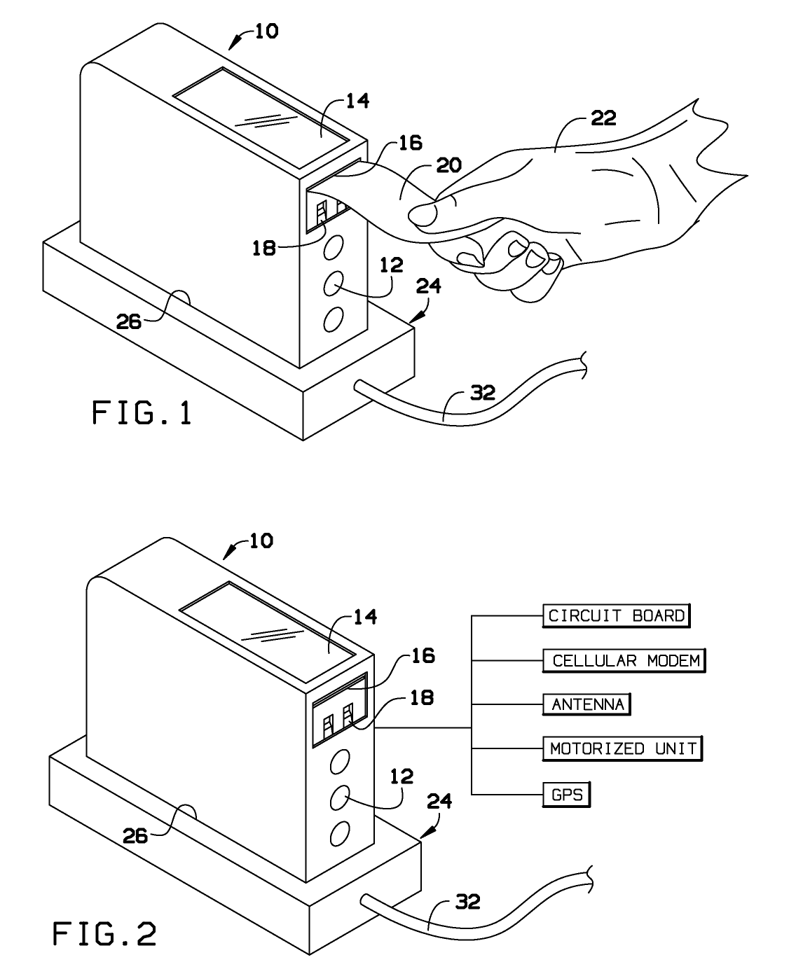

Referring now to FIGS. 1 through 4, a physician can prescribe a medication regimen to a patient 22 and enter this information into the local doctor's office database software. The physician can then provide the patient with a handheld dispensing unit 10 (also referred to as device 10). The software uploads certain elements of this information to server software, including a unique identifier for the device provided to the patient, an anonymous identifier for the patient, and the patient's dosage and regimen.

The patient can take the device 10 to the pharmacy along with doctor's prescription to have the prescription filled and the device loaded. The pharmacist accesses the server to confirm the regimen and match it to the device identifier which includes, for example, a bar code printed on the bottom of the device 10. The pharmacist uses a special piece of equipment designed to load the handheld device 10 with the medication 20 and downloads programming from the server to the device 10 to activate it for the appropriate regimen and dispensing instructions. The handheld device 10 is then returned to the patient to begin using.

A timer inside the device 10 counts down the interval to the next available dosage. This countdown may be momentarily displayed on a digital display screen 14 on top of the device 10 by pressing one of the buttons 12 on the side of the device 10. When the time interval is reached and a dose is available for dispensing, the device 10 can produce an audible and/or visual alert (a parameter that may be set by the patient). At this point, the patient can press a 4-digit combination “PIN” using the buttons 12 on the side of the device 10 and when the correct PIN is entered, the motorized mechanism in the device 10 is activated and one “strip” of medication film 20 is dispensed through a slot 16 in the side of the device 10. After this dosage is dispensed, the device 10 is now “locked” again and begins counting down to the next dosage interval at which point the above steps are repeated until the entire supply of medication has been exhausted.

Each time a dose is dispensed, the device 10 sends a message to the server indicating such and this is recorded in an activity trail log. If an interval is reached but the patient fails to dispense a dosage after 1 hour, the device 10 sends a message to the server indicating as such and this is recorded in an activity trail log. Depending upon setting and parameters set by the prescribing doctor, this may also trigger a notification to the doctor and/or to the patient via SMS message or email that a dosage was missed.

If the device 10 is lost or stolen, the patient reports this immediately to the doctor via telephone or online connection to the server itself. Such report then triggers a signal to be sent from the server to the device 10, permanently locking it, triggering it to return its GPS coordinates, and triggering destruction of the medication inside via mechanical and/or chemical means.

The device 10 is also equipped with internal sensors that will be triggered by tampering (i.e., attempts to open the device, break, crack, or pry) and this will send a signal to the server that tampering has been detected. Upon receiving a tampering signal the server will return instructions to lock the device 10 and/or destroy the medication 20 as in the case if the device 10 is lost or stolen.

All of the above activities can generate an entry into the activity trail log. This activity trail log can be used to determine patient compliance, device location, and the like.

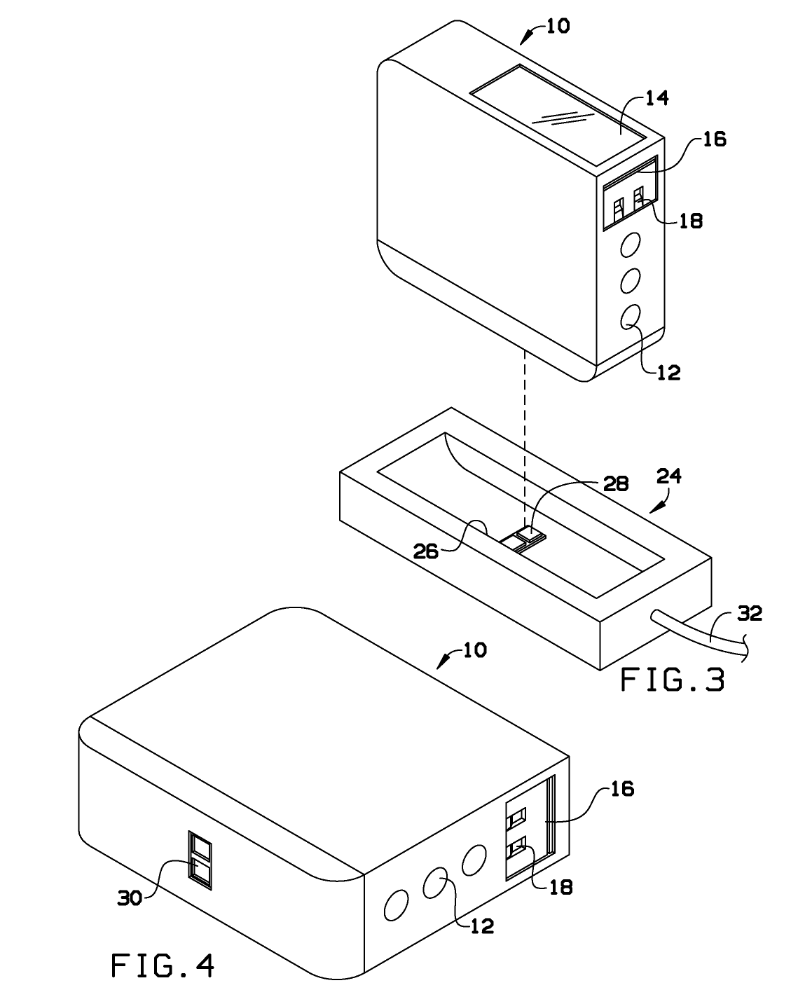

A circuit board (see FIG. 2) containing the processor and electronics necessary to control all of the functions is at the heart of the device 10. Also included in the electronics is a cellular modem with antenna, or some other communication device, for communication wirelessly with the server. The digital display 14 is the output device connected to the main circuit board. The buttons 12 on, for example, the side of the device, are the input device connected to the main board. Wiring from the main board to the motorized unit controls dispensing of doses of medication 20 through the slot 16 opening in the side of the device. Wiring can connect from the main board to a “destruction mechanism” which may be either a mechanical “crushing” device and/or a release of a liquid or chemical gel from a small plastic reservoir that serves to render the medication useless. The device contains software “firmware” on board to control basic independent functions such as countdown, timer, locking and unlocking, dispensing doses, activating destructive mechanism, and the like. The onboard software is also programmed to send certain predefined messages to the server and to receive certain predefined signals from the server wirelessly which, in turn, activate certain other functions described above. Programming/filling connection ports 18 can be provided to send information to or obtain information from the device 10. A built in global positioning system is also included in the electronics and can sent its coordinates back to the server when signaled to do so.

The external housing of the device can be made from molded plastic or metal, for example. The circuit board could be manufactured and electronic components attached to it. A motorized mechanism could be manufactured using miniature low voltage electric motors and rubber wheels for transporting the medication strips. A device using two platens and a motor could be manufactured in order to crush and destroy the medication or a spike would pierce the medication or a shredder with small blades would shred the medication or a small plastic reservoir would contain a chemical fluid or gel that when released inside the device would render the medication unusable. Currently existing and available electronic for cellular modems and mobile GPS could be purchased and incorporated into the device to provide wireless communication and positioning capabilities. Software could be developed and written for the internal firmware as well as the server application and the doctor's office database application. A digital display could be manufactured as the output for the device. Buttons could be installed on the side of the device for input.

The device 10 can rest in a base 24 having a base slot 26 that is sized to fit the device 10 therein. A dispensing unit charge contact 30 can be disposed on the bottom of the device 10 to contact a base charge contact 28 in the base 24. A base cord 32 can provide power to the base 24, which, through the charge contacts 28, 30, can provide current to power or charge the device 10.

The device 10 of the present invention may be redesigned to facilitate the dispensing of pills, tablets, or capsules in addition to or instead of buprenorphine-naloxone sublingual film strips. The device of the present invention could be useful in the treatment of patients for any number of other medical conditions in which patient adherence to a rigid medication regimen is critical. Examples might include, but not be limited to, pain management, psychiatric illnesses, diabetes, and heart disease. Another important possible use for the device of the present invention would be for remotely controlling, monitoring, and dispensing proper medication regimens to the elderly or disabled. The technology contained within the device of the present invention could also be modified and used for reporting laboratory test results back to a patient's doctor or for managing medical emergencies by transmitting a signal or for allowing tracking of patient adherence to a treatment program, for example a counselor or therapist may enter a passcode into the device to confirm patient showed up for an appointment.

It should be understood, of course, that the foregoing relates to exemplary embodiments of the invention and that modifications may be made without departing from the spirit and scope of the invention as set forth in the following claims.

What is claimed is:

1. A device for dispensing medication comprising:
a programming connection adapted to permit programming of the device, the programming connection being either a wireless connection or a physical connection;
a dispenser adapted to dispense the medication at a predetermined medicine issuance time; and
a plurality of buttons adapted to permit a user to enter a code at the medicine issuance time, prior to the dispenser dispensing the medication.

2. The device of claim 1, wherein the medication is dispensed as a strip out of a slot in the device.

3. The device of claim 1, wherein the medication is a buprenorphine/naloxone strip.

4. The device of claim 1, further comprising a digital display on at least a portion of the device.

5. The device of claim 1, further comprising a base having a base slot in which a bottom side of the device fits.

6. The device of claim 5, further comprising charge contacts on the bottom side of the device and in the base slot, the charge contacts providing power from the base to the device.

7. The device of claim 1, further comprising a global positioning device disposed in the device for locating the device if lost.

8. A device for dispensing dosage strips of medication, comprising:
a programming connection adapted to permit programming of the device, the programming connection being either a wireless connection or a physical connection;
a dispenser adapted to dispense the medication at a predetermined medicine issuance time;
a plurality of buttons adapted to permit a user to enter a code at the medicine issuance time, prior to the dispenser dispensing the medication; and
a global positioning device disposed in the device for locating the device if lost.

9. The device of claim 8, wherein the medication is a buprenorphine/naloxone strip.

10. The device of claim 8, further comprising:
a base having a base slot in which a bottom side of the device fits; and
charge contacts on the bottom side of the device and in the base slot, the charge contacts providing power from the base to the device.
